(19) United States
(12) Patent Application Publication
(10) Pub. No.: US 2025/0226957 A1
(43) Pub. Date: Jul. 10, 2025

(54) SIGNAL TRANSMISSION METHOD, COMMUNICATION SYSTEM, AND COMMUNICATION APPARATUS

(71) Applicant: HUAWEI TECHNOLOGIES CO., LTD., Shenzhen (CN)

(72) Inventors: Tianhang Yu, Hangzhou (CN); Gongzheng Zhang, Hangzhou (CN); Xiaolu Wang, Hangzhou (CN); Yunfei Qiao, Hangzhou (CN); Ying Chen, Hangzhou (CN); Rong Li, Boulogne Billancourt (FR); Jun Wang, Hangzhou (CN)

(73) Assignee: HUAWEI TECHNOLOGIES CO., LTD., Shenzhen (CN)

(21) Appl. No.: 19/093,024

(22) Filed: Mar. 27, 2025

Related U.S. Application Data
(63) Continuation of application No. PCT/CN2023/121006, filed on Sep. 25, 2023.

(30) Foreign Application Priority Data
Sep. 28, 2022 (CN) 202211193545.X

(51) Int. Cl. H04L 5/00; H04L 27/26; H04W 72/0446; H04W 72/0453

(52) U.S. Cl. CPC H04L 5/0092; H04L 27/2614; H04W 72/0446; H04W 72/0453

(57) ABSTRACT

This application provides a signal transmission method, a communication system, and a communication apparatus. A second communication apparatus sends a first message. Correspondingly, a first communication apparatus receives the first message. The first message includes first resource indication information. When the first resource indication information is a first value, the first resource indication information indicates a third communication apparatus to transmit data on a first subcarrier group of the first communication apparatus, and the first subcarrier group does not include a data subcarrier of the first communication apparatus. The second communication apparatus sends a second message. Correspondingly, the third communication apparatus receives the second message. The second message includes second resource indication information. When the second resource indication information is a second value, the second resource indication information indicates the third communication apparatus to transmit data on the first subcarrier group.

### CROSS-REFERENCE TO RELATED APPLICATIONS

This application is a continuation of International Application No. PCT/CN2023/121006, filed on Sep. 25, 2023, which claims priority to Chinese Patent Application No. 202211193545.X, filed on Sep. 28, 2022. The disclosures of the aforementioned applications are hereby incorporated by reference in their entireties.

### TECHNICAL FIELD

This application relates to the field of communication technologies, and in particular, to a signal transmission method, a communication system, and a communication apparatus.

### BACKGROUND

An orthogonal frequency division multiplexing (orthogonal frequency division multiplexing, OFDM) technology is a one of multi-carrier broadband digital modulation and demodulation technologies. It divides one channel into several subcarriers orthogonal to each other, divides high-speed serial data streams into same quantities of parallel low-speed data sub-streams, and modulates the data sub-streams to different orthogonal subcarriers respectively. Because a waveform of an OFDM signal output by a transmit end is a superimposition of all subcarrier waveforms, the OFDM signal has a high peak-to-average power ratio (peak to average power ratio, PAPR).

In an OFDM system, a method for reducing a transmitted signal is that the transmit end reserves a part of subcarriers for reducing a PAPR of the transmitted signal but not for sending data, that is, the transmit end sends wanted data on only a part of subcarriers. For example, the subcarrier used to reduce the PAPR of the transmitted signal may be referred to as a reserved subcarrier, and the subcarrier used to send the wanted data may be referred to as a data subcarrier. The transmit end may map to-be-transmitted data to the data subcarrier, and generate a data signal through inverse discrete Fourier transform (inverse discrete fourier transform, IDFT). The transmit end generates a suppression signal on the reserved subcarrier, so that a PAPR of a transmitted signal generated by superimposing the suppression signal and the data signal is less than a PAPR of the data signal, thereby reducing the PAPR of the transmitted signal.

However, in this method, there is a part of subcarriers that cannot carry wanted data, resulting in a loss of spectral efficiency.

### SUMMARY

Embodiments of this application disclose a signal transmission method, a communication system, and a communication apparatus, to improve spectral efficiency.

According to a first aspect, an embodiment of this application provides a signal transmission method. The method may be performed by a first communication apparatus, or may be performed by a component (for example, a chip or a circuit) of the first communication apparatus. This is not limited. The method includes:

A first communication apparatus receives a first message sent by a second communication apparatus, where the first message includes first resource indication information, when the first resource indication information is a first value, the first resource indication information indicates a third communication apparatus to transmit data on a first subcarrier group of the first communication apparatus, and the first subcarrier group does not include a data subcarrier of the first communication apparatus; and the first communication apparatus sends a first transmitted signal based on the first message.

In this embodiment of this application, when the first resource indication information is the first value, the first communication apparatus does not transmit wanted data on the first subcarrier group. For example, the first communication apparatus may reduce a PAPR of the first transmitted signal by using the first subcarrier group. The first resource indication information indicates the third communication apparatus to transmit data on the first subcarrier group, so that the first subcarrier group carries the data of the third communication apparatus, and spectrum resources of the first subcarrier group can be fully used. This avoids a waste of the spectrum resources and improves spectral efficiency.

In a possible implementation, the first transmitted signal includes a first signal and a second signal, the first signal is a signal on the first subcarrier group, the second signal is a signal on a second subcarrier group, and the second subcarrier group includes the data subcarrier.

In this embodiment of this application, the first transmitted signal sent by the first communication apparatus is obtained by superimposing the first signal on the first subcarrier group and the second signal on the second subcarrier group. The second signal may carry first data, and the first data is data to be sent by the first communication apparatus to the second communication apparatus. The first signal is not used to carry wanted data, and the first signal is related to the second signal, that is, the first signal may be determined based on the second signal.

In a possible implementation, a peak-to-average power ratio PAPR of the first transmitted signal is less than or equal to a PAPR of the second signal.

In this embodiment of this application, the first communication apparatus may reduce the PAPR of the first transmitted signal by using the first subcarrier group. The first communication apparatus maps the to-be-transmitted first data to the second subcarrier group, to generate the second signal. The first communication apparatus generates the first signal on the first subcarrier group, and the PAPR of the first transmitted signal generated by superimposing the first signal and the second signal is less than or equal to the PAPR of the second signal, so that the PAPR of the first transmitted signal can be reduced, thereby avoiding or mitigating nonlinear distortion caused by an excessively high PAPR of the first transmitted signal.

In a possible implementation, the first message further includes a first time-frequency resource and first indication information, the first time-frequency resource indicates a time-frequency resource related to the first subcarrier group and a time-frequency resource related to the second subcarrier group, and the first indication information indicates a location of the first subcarrier group and a location of the second subcarrier group; and the method further includes:

The first communication apparatus generates the first signal and the second signal based on the first time-frequency resource and the first indication information.

In this embodiment of this application, the first communication apparatus may determine, based on the first time-frequency resource and the first indication information, the time-frequency resource corresponding to the first subcarrier group, the time-frequency resource corresponding to the second subcarrier group, the location of the first subcarrier group, and the location of the second subcarrier group, so that the first communication apparatus can generate the first signal on the first subcarrier group and generate the second signal on the second subcarrier group.

In a possible implementation, the method further includes:

The first communication apparatus generates the first signal on the first subcarrier group based on a first sequence, where the first sequence is a sequence that is in a sequence group and that enables the PAPR of the first transmitted signal to meet a preset condition.

In this embodiment of this application, the sequence group may be a sequence group agreed on by the first communication apparatus and the second communication apparatus, the sequence group may include one or more sequences, and the first sequence is the sequence that is in the sequence group and that enables the PAPR of the first transmitted signal to meet the preset condition. The first communication apparatus may map the first sequence to the first subcarrier group, to generate the first signal. The first communication apparatus may directly carry the first sequence on the first subcarrier group, so that the first transmitted signal obtained by superimposing the generated first signal and the second signal meets the preset condition, and complexity of a process of generating the first signal can be reduced.

In a possible implementation, the method further includes:

The first communication apparatus sends second indication information, where the second indication information indicates the first sequence.

In this embodiment of this application, the first communication apparatus may indicate the first sequence based on the second indication information, so that the second communication apparatus can quickly determine the first sequence based on the second indication information.

In a possible implementation, the method further includes:

The first communication apparatus generates the first signal on the first subcarrier group based on a PAPR suppression parameter and the second signal; and the first communication apparatus sends third indication information, where the third indication information indicates the PAPR suppression parameter.

In this embodiment of this application, the first communication apparatus may indicate the PAPR suppression parameter based on the third indication information, so that the second communication apparatus can reconstruct the first signal based on the PAPR suppression parameter.

In a possible implementation, the PAPR suppression parameter includes at least one of the following: a PAPR suppression threshold, tone reservation TR algorithm indication information, and a TR algorithm iteration round quantity.

In a possible implementation, the first message further includes a first threshold, a power of the first signal is less than or equal to the first threshold, the first threshold is related to at least one of the following: a channel capacity, a power of a third signal, a modulation order of the third signal, and a bit rate of the third signal, and the third signal is a signal sent by the third communication apparatus on the first subcarrier group.

In this embodiment of this application, the second communication apparatus may limit the power of the first signal, so that the second communication apparatus can use the first signal as the first signal as an interference signal of the third signal, and can demodulate, from the first subcarrier group, second data sent by the third communication apparatus.

According to a second aspect, an embodiment of this application provides a signal transmission method. The method may be performed by a second communication apparatus, or may be performed by a component (for example, a chip or a circuit) of the second communication apparatus. This is not limited. The method includes:

A second communication apparatus sends a first message to a first communication apparatus, where the first message includes first resource indication information, when the first resource indication information is a first value, the first resource indication information indicates a third communication apparatus to transmit data on a first subcarrier group of the first communication apparatus, and the first subcarrier group does not include a data subcarrier of the first communication apparatus; and the second communication apparatus sends a second message to the third communication apparatus, where the second message includes second resource indication information, and when the second resource indication information is a second value, the second resource indication information indicates the third communication apparatus to transmit data on the first subcarrier group.

In this embodiment of this application, the first communication apparatus does not transmit wanted data on the first subcarrier group. For example, the first communication apparatus may reduce a PAPR of the first transmitted signal by using the first subcarrier group. The second communication apparatus may indicate, based on the first resource indication information and the second resource indication information, the third communication apparatus to transmit data on the first subcarrier group, so that the first subcarrier group carries the data of the third communication apparatus, and spectrum resources of the first subcarrier group can be fully used. This avoids a waste of the spectrum resources and improves spectral efficiency.

In a possible implementation, the method further includes:

The second communication apparatus receives a first received signal, where the first received signal is obtained by superimposing a first transmitted signal sent by the first communication apparatus and a third signal sent by the third communication apparatus on the first subcarrier group; and the second communication apparatus determines the third signal from the first received signal.

In this embodiment of this application, the first transmitted signal carries first data transmitted by the first communication apparatus, and the third signal carries second data transmitted by the third communication apparatus. The first received signal received by the second communication apparatus is a superimposition of the first transmitted signal and the third signal, and the second communication apparatus determines the third signal from the first received signal, so that the second data can be demodulated from the third signal.

In a possible implementation, the first transmitted signal includes a first signal and a second signal, the first signal is a signal on the first subcarrier group, the second signal is a signal on a second subcarrier group, and the second subcarrier group includes the data subcarrier.

In this embodiment of this application, the first transmitted signal is obtained by superimposing the first signal on the first subcarrier group and the second signal on the second subcarrier group. In other words, a signal that is of the first received signal and that is on the second subcarrier group is the second signal, and a signal that is of the first received signal and that is on the first subcarrier group is a superimposition of the first signal and the third signal. The second signal carries the first data transmitted by the first communication apparatus, and the first signal does not carry wanted data. The first signal is related to the second signal, that is, the second communication apparatus may determine the first signal based on the second signal, to determine the third signal.

In a possible implementation, a peak-to-average power ratio PAPR of the first transmitted signal is less than or equal to a PAPR of the second signal.

In this embodiment of this application, the first communication apparatus may reduce the PAPR of the first transmitted signal by using the first subcarrier group. In other words, the first signal is used to reduce the PAPR of the first transmitted signal, thereby avoiding or mitigating nonlinear distortion caused by an excessively high PAPR of the first transmitted signal.

In a possible implementation, the first message further includes a first time-frequency resource and first indication information, the first time-frequency resource indicates a time-frequency resource related to the first subcarrier group and a time-frequency resource related to the second subcarrier group, and the first indication information indicates a location of the first subcarrier group and a location of the second subcarrier group.

In this embodiment of this application, the second communication apparatus may indicate, based on the first time-frequency resource and the first indication information, the time-frequency resource corresponding to the first subcarrier group, the time-frequency resource corresponding to the second subcarrier group, the location of the first subcarrier group, and the location of the second subcarrier group, so that the first communication apparatus can generate the first signal on the first subcarrier group and generate the second signal on the second subcarrier group.

In a possible implementation, the second message further includes a second time-frequency resource and fourth indication information, the second time-frequency resource indicates the time-frequency resource related to the first subcarrier group, and the fourth indication information indicates the location of the first subcarrier group.

In this embodiment of this application, the second communication apparatus may indicate, based on the second time-frequency resource and the fourth indication information, the time-frequency resource corresponding to the first subcarrier group and the location of the first subcarrier group, so that the third communication apparatus can generate the third signal on the first subcarrier group.

In a possible implementation, that the second communication apparatus determines the third signal from the first received signal includes:

The second communication apparatus determines the second signal that is of the first received signal and that is on the second subcarrier group; the second communication apparatus determines the first transmitted signal based on the second signal; and the second communication apparatus performs interference cancellation on the first received signal based on the first transmitted signal, to obtain the third signal.

In this embodiment of this application, a signal that is of the first received signal and that is on the second subcarrier group is the second signal, and a signal that is of the first received signal and that is on the first subcarrier group is a superimposition of the first signal and the third signal. The second signal carries the first data transmitted by the first communication apparatus, and the first signal does not carry wanted data. The first signal is related to the second signal, that is, the second communication apparatus may determine the first signal based on the second signal, to reconstruct the first transmitted signal. Therefore, the second communication apparatus can perform interference cancellation on the first received signal based on the first transmitted signal, to obtain the third signal.

In a possible implementation, that the second communication apparatus determines the first transmitted signal based on the second signal includes:

The second communication apparatus generates the first signal on the first subcarrier group based on a first sequence; and the second communication apparatus superimposes the first signal and the second signal to obtain the first transmitted signal, where the first sequence is a sequence that is in a sequence group and that enables the peak-to-average power ratio PAPR of the first transmitted signal to meet a preset condition.

In this embodiment of this application, the sequence group may be a sequence group agreed on by the first communication apparatus and the second communication apparatus, the sequence group may include one or more sequences, and the first sequence is the sequence that is in the sequence group and that enables the PAPR of the first transmitted signal to meet the preset condition. The second communication apparatus may map the first sequence to the first subcarrier group, to generate the first signal. The second communication apparatus may directly carry the first sequence on the first subcarrier group, so that the first transmitted signal obtained by superimposing the generated first signal and the second signal meets the preset condition, and complexity of a process of generating the first signal can be reduced.

In a possible implementation, the method further includes:

The second communication apparatus receives second indication information, where the second indication information indicates the first sequence.

In this embodiment of this application, the second communication apparatus may quickly determine the first sequence from the sequence group based on the second indication information.

In a possible implementation, the method further includes:

The second communication apparatus receives third indication information, where the third indication information indicates a PAPR suppression parameter; and
that the second communication apparatus determines the first transmitted signal based on the second signal includes:
the second communication apparatus generates the first signal on the first subcarrier group based on the PAPR suppression parameter and the second signal; and the second communication apparatus superimposes the first signal and the second signal to obtain the first transmitted signal.

In this embodiment of this application, the second communication apparatus can reconstruct the first transmitted signal based on the PAPR suppression parameter and the second signal, so that the third signal can be determined from the first received signal.

In a possible implementation, the PAPR suppression parameter includes at least one of the following: a PAPR suppression threshold, tone reservation TR algorithm indication information, and a TR algorithm iteration round quantity.

In a possible implementation, the first message further includes a first threshold, a power of the first signal is less than or equal to the first threshold, the first threshold is related to at least one of the following: a channel capacity, a bit rate of the third signal, a power of the third signal, and a modulation order of the third signal, and the first signal is a signal that is of the first transmitted signal and that is on the first subcarrier group.

In this embodiment of this application, the second communication apparatus may limit the power of the first signal, so that the second communication apparatus can use the first signal as the first signal as an interference signal of the third signal, and can demodulate, from the first subcarrier group, second data sent by the third communication apparatus.

According to a third aspect, an embodiment of this application provides a signal transmission method. The method may be performed by a third communication apparatus, or may be performed by a component (for example, a chip or a circuit) of the third communication apparatus. This is not limited. The method includes:

A third communication apparatus receives a second message sent by a second communication apparatus, where the second message includes second resource indication information, and when the second resource indication information is a second value, the second resource indication information indicates the third communication apparatus to transmit data on a first subcarrier group; and the third communication apparatus sends a third signal on the first subcarrier group based on the second message.

In this embodiment of this application, the first communication apparatus does not transmit data on the first subcarrier group. For example, the first communication apparatus may reduce a PAPR of a first transmitted signal by using the first subcarrier group. The third communication apparatus may send the third signal on the first subcarrier group based on the second resource indication information, so that the first subcarrier group carries the data of the third communication apparatus, and spectrum resources of the first subcarrier group can be fully used. This avoids a waste of the spectrum resources and improves spectral efficiency.

In a possible implementation, the second message further includes a second time-frequency resource and fourth indication information, the second time-frequency resource indicates the time-frequency resource related to the first subcarrier group, and the fourth indication information indicates the location of the first subcarrier group; and that the third communication apparatus sends the third signal on the first subcarrier group based on the second message includes:

The third communication apparatus sends the third signal on the first subcarrier group based on the second time-frequency resource and the fourth indication information.

In this embodiment of this application, the third communication apparatus may determine, based on the second time-frequency resource and the fourth indication information, the time-frequency resource and the location that correspond to the first subcarrier group, so that the third communication apparatus can send the third signal on the first subcarrier group.

According to a fourth aspect, an embodiment of this application provides a communication system. The communication system includes a first communication apparatus, a second communication apparatus, and a third communication apparatus. The first communication apparatus is configured to perform the method in any one of the first aspect or the possible implementations of the first aspect, the second communication apparatus is configured to perform the method in any one of the second aspect or the possible implementations of the second aspect, and the third communication apparatus is configured to perform the method in any one of the third aspect or the possible implementations of the third aspect.

According to a fifth aspect, an embodiment of this application provides a communication apparatus, configured to perform the method in any one of the first aspect or the possible implementations. The communication apparatus includes units that perform the method in any one of the first aspect or the possible implementations of the first aspect.

According to a sixth aspect, an embodiment of this application provides a communication apparatus, configured to perform the method in any one of the second aspect or the possible implementations. The communication apparatus includes units that perform the method in any one of the second aspect or the possible implementations of the second aspect.

According to a seventh aspect, an embodiment of this application provides a communication apparatus, configured to perform the method in any one of the third aspect or the possible implementations. The communication apparatus includes units that perform the method in any one of the third aspect or the possible implementations of the third aspect.

According to an eighth aspect, an embodiment of this application provides a communication apparatus. The communication apparatus includes a processor, configured to perform the method in any one of the first aspect or the possible implementations. Alternatively, the processor is configured to execute a program stored in a memory. When the program is executed, the method in any one of the first aspect or the possible implementations is performed.

In a possible implementation, the memory is located outside the communication apparatus.

In a possible implementation, the memory is located inside the communication apparatus.

In this embodiment of this application, the processor and the memory may alternatively be integrated into one device. In other words, the processor and the memory may alternatively be integrated together.

In a possible implementation, the communication apparatus further includes a transceiver. The transceiver is configured to: receive or send a signal.

According to a ninth aspect, an embodiment of this application provides a communication apparatus. The communication apparatus includes a processor, configured to perform the method in any one of the second aspect or the possible implementations. Alternatively, the processor is configured to execute a program stored in a memory. When the program is executed, the method in any one of the second aspect or the possible implementations is performed.

In a possible implementation, the memory is located outside the communication apparatus.

In a possible implementation, the memory is located inside the communication apparatus.

In this embodiment of this application, the processor and the memory may alternatively be integrated into one device. In other words, the processor and the memory may alternatively be integrated together.

In a possible implementation, the communication apparatus further includes a transceiver. The transceiver is configured to: receive or send a signal.

According to a tenth aspect, an embodiment of this application provides a communication apparatus. The communication apparatus includes a processor, configured to perform the method in any one of the third aspect or the possible implementations. Alternatively, the processor is configured to execute a program stored in a memory. When the program is executed, the method in any one of the third aspect or the possible implementations is performed.

In a possible implementation, the memory is located outside the communication apparatus.

In a possible implementation, the memory is located inside the communication apparatus.

In this embodiment of this application, the processor and the memory may alternatively be integrated into one device. In other words, the processor and the memory may alternatively be integrated together.

In a possible implementation, the communication apparatus further includes a transceiver. The transceiver is configured to: receive or send a signal.

According to an eleventh aspect, an embodiment of this application provides a communication apparatus. The communication apparatus includes a logic circuit and an interface, and the logic circuit is coupled to the interface. The interface is configured to input a first message and output a first transmitted signal.

It may be understood that, for descriptions of the first message and the first transmitted signal, refer to the method in any one of the first aspect or the possible implementations. Details are not described herein again.

According to a twelfth aspect, an embodiment of this application provides a communication apparatus. The communication apparatus includes a logic circuit and an interface, and the logic circuit is coupled to the interface. The interface is configured to output a first message and a second message.

It may be understood that for descriptions of the first message and the second message, refer to the method in any one of the second aspect or the possible implementations. Details are not described herein again.

According to a thirteenth aspect, an embodiment of this application provides a communication apparatus. The communication apparatus includes a logic circuit and an interface, and the logic circuit is coupled to the interface. The interface is configured to input a second message and output a third signal.

It may be understood that, for descriptions of the second message and the third signal, refer to the method in any one of the third aspect or the possible implementations. Details are not described herein again.

According to a fourteenth aspect, an embodiment of this application provides a computer-readable storage medium. The computer-readable storage medium is configured to store a computer program. When the computer program is run on a computer, the method in any one of the first aspect or the possible implementations of the first aspect is performed, the method in any one of the second aspect or the possible implementations of the second aspect is performed, or the method in any one of the third aspect or the possible implementations of the third aspect is performed.

According to a fifteenth aspect, an embodiment of this application provides a computer program product. The computer program product includes a computer program or computer code. When the computer program product runs on a computer, the method in any one of the first aspect or the possible implementations of the first aspect is performed, the method in any one of the second aspect or the possible implementations of the second aspect is performed, or the method in any one of the third aspect or the possible implementations of the third aspect is performed.

### BRIEF DESCRIPTION OF DRAWINGS

The following describes the accompanying drawings used in embodiments of this application.

FIG. 1 is a diagram of a structure of a communication system according to an embodiment of this application;

FIG. 2 is a diagram of a structure of another communication system according to an embodiment of this application;

FIG. 3 shows processing procedures of a transmit end and a receive end according to an embodiment of this application;

FIG. 4 is a diagram of interaction of a signal transmission method according to an embodiment of this application;

FIG. 5 is a diagram of a TR pattern according to an embodiment of this application;

FIG. 6 is a diagram of interaction of another signal transmission method according to an embodiment of this application;

FIG. 7 is a diagram of interaction of still another signal transmission method according to an embodiment of this application;

FIG. 8 is a waveform diagram of a fourth signal according to an embodiment of this application;

FIG. 9 is a diagram of interaction of still another signal transmission method according to an embodiment of this application; and

FIG. 10 to FIG. 12 are diagrams of structures of a communication apparatus according to an embodiment of this application.

### DESCRIPTION OF EMBODIMENTS

In the specification, claims, and accompanying drawings of this application, the terms “first”, “second”, and the like are merely intended to distinguish between different objects, but do not limit a sequence, a time sequence, a priority, or an importance degree of a plurality of objects. In embodiments of this application, “a plurality of” refers to two or more. In addition, terms such as “include” and “have” and any other variants thereof are intended to cover a non-exclusive inclusion. For example, processes, methods, systems, products, or devices that include a series of steps or units are not limited to listed steps or units, but instead, optionally further include steps or units that are not listed, or optionally further include other steps or units inherent to these processes, methods, products, or devices. In addition, the character “/” generally indicates an “or” relationship between the associated objects.

An “embodiment” mentioned in this specification means that a particular feature, structure, or characteristic described with reference to the embodiment may be included in at least one embodiment of this application. The phrase shown in various locations in the specification may not necessarily refer to a same embodiment, and is not an independent or optional embodiment exclusive from another embodiment. It may be understood explicitly and implicitly by a person skilled in the art that embodiments described herein may be combined with other embodiments.

A terminal device in embodiments of this application may be user equipment (user equipment, UE), an access terminal, a subscriber unit, a subscriber station, a mobile station, a mobile console, a remote station, a remote terminal, a mobile device, a user terminal, a terminal, a wireless communication device, a user agent, or a user apparatus. The terminal device may further refer to a terminal apparatus that implements a communication function in this application, for example, a communication module or a communication chip in the terminal apparatus. The terminal device may be a device that provides voice and/or data connectivity for a user, or may include a device that can perform sidelink (sidelink) communication, for example, a vehicle-mounted terminal, or a handheld terminal that can perform vehicle-to-everything (vehicle-to-everything, V2X) communication. For example, the terminal device may alternatively be a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a computing device, another processing device connected to a wireless modem, a vehicle-mounted device, a wearable device, a terminal device in a future 5G network, a terminal device in a future evolved public land mobile network (public land mobile network, PLMN), or the like. This is not limited in embodiments of this application.

A network device in embodiments of this application may be a device that connects a terminal device to a wireless network, and may be specifically a base station. The base station may include various forms of base stations, for example, a macro base station, a micro base station (also referred to as a small cell), a relay station, an access point, or the like, or a relay station or an access point, or a vehicle-mounted device, a wearable device, a next-generation NodeB (the next generation NodeB, gNB) in a 5G system, or a base station in a future evolved PLMN network. In a possible manner, the network device may be a base station (for example, a gNB) having an architecture in which a central unit (centralized unit, CU) and a distributed unit (distributed unit, DU) are separated. The network device may further refer to a network apparatus that implements a communication function in this application, for example, a communication module or a communication chip in the network apparatus.

The technical solutions provided in embodiments of this application may be applied to various communication systems, for example, a 5th generation (5th generation, 5G) mobile communication system, a narrowband internet of things (narrow band-internet of things, NB-IoT) system, a wireless local area network (wireless local area networks, WLAN), wireless fidelity (wireless fidelity, Wi-Fi), a device to device (device to device, D2D) communication system, a machine to machine (machine to machine, M2M) communication system, a machine type communication (machine type communication, MTC) system, a vehicle to vehicle (V2V) communication system, another future evolved communication system, a next-generation communication system, and the like. Details are not listed one by one herein. Embodiments of this application may also be applied to a non-terrestrial network (non-terrestrial networks, NTN), for example, a satellite communication system. Satellite communication has advantages of wide coverage, a long communication distance, high reliability, high flexibility, and a high throughput.

FIG. 1 is a diagram of a structure of a communication system according to an embodiment of this application. As shown in FIG. 1, the communication system may include at least one network device and at least one terminal device. FIG. 1 shows one network device and two terminal devices. The network device provides communication services for the terminal devices. The network device may include a baseband unit (baseband unit, BBU) and a remote radio unit (remote radio unit, RRU). The BBU and the RRU may be placed at different places. For example, the RRU is remote and placed in a heavy-traffic area, and the BBU is placed in a central equipment room. Alternatively, the BBU and the RRU may be placed in a same equipment room. Alternatively, the BBU and the RRU may be different components at a same rack.

For example, a transmit end and a receive end that exchange data in the communication system may perform data adjustment and demodulation by using an orthogonal frequency division multiplexing (orthogonal frequency division multiplexing, OFDM) technology. The OFDM technology is a multi-carrier broadband digital modulation and demodulation technology. A basic idea of this technology is to divide one channel into several orthogonal subcarriers, divide high-speed serial data streams into same quantities of parallel low-speed data sub-streams, and modulate the data sub-streams to different orthogonal subcarriers respectively. The OFDM technology can effectively suppress inter-symbol interference, improve spectrum utilization, and have a good anti-multipath interference capability. The OFDM technology is used for signal modulation. Because a waveform of an OFDM signal output by the transmit end is a superimposition of all subcarrier waveforms, the OFDM signal has a high peak-to-average power ratio (peak to average power ratio, PAPR). For example, if phases of modulated data on N subcarriers are the same at a moment, a power of the OFDM signal is N times an average power.

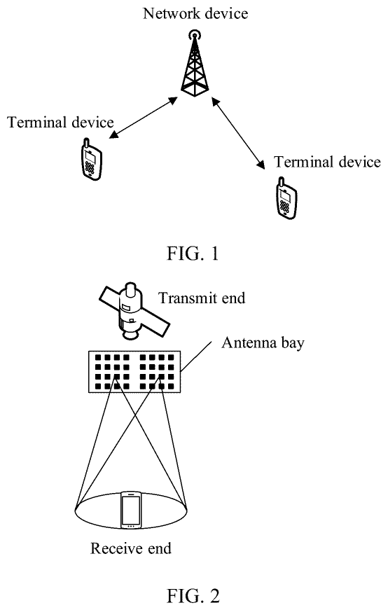

FIG. 2 is a diagram of a structure of another communication system according to an embodiment of this application. As shown in FIG. 2, the communication system may include a transmit end and a receive end. The transmit end may include a plurality of antenna bays, and power amplifiers between any two of the plurality of antenna bays are independent of each other. In other words, the any two antenna bays at the transmit end can independently send signals. For example, the transmit end may be the terminal device described above, or may be the network device described above, and the receive end may be the terminal device described above, or may be the network device described above. This is not limited in this application.

In some scenarios, for example, in satellite communication, a communication distance is long and a link budget is poor, so that efficiency of a power amplifier is improved. However, when a PAPR of a transmitted signal (for example, the OFDM signal) output by the transmit end is high, a nonlinear power amplifier causes nonlinear distortion of the transmitted signal. Therefore, in the satellite communication scenario, there is a higher requirement for reducing the PAPR of the transmitted signal.

In an OFDM system, a method for reducing a transmitted signal is that the transmit end reserves a part of subcarriers to reduce a PAPR of the transmitted signal and not to send data, that is, the transmit end sends wanted data on only the other part of subcarriers. For example, the subcarrier used to reduce the PAPR of the transmitted signal may be referred to as a reserved subcarrier, and the subcarrier used to send the wanted data may be referred to as a data subcarrier. The transmit end may map to-be-transmitted data to the data subcarrier, and generate a data signal through inverse discrete Fourier transform (inverse discrete Fourier transform, IDFT). The transmit end may reduce the PAPR of the transmitted signal on the reserved subcarrier, that is, the transmit end may generate a suppression signal on the reserved subcarrier, so that a PAPR of a transmitted signal generated by superimposing the suppression signal and the data signal is less than a PAPR of the data signal, thereby reducing the PAPR of the transmitted signal.

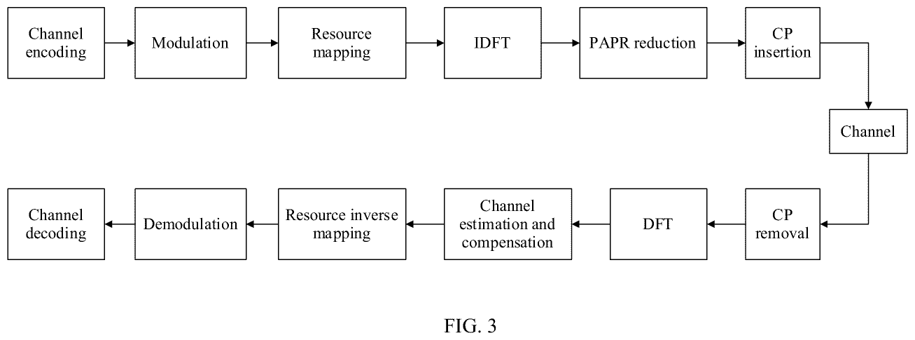

For example, for processing procedures of the transmit end and the receive end, refer to FIG. 3. As shown in FIG. 3, the processing procedure of the transmit end mainly includes channel encoding, modulation, resource mapping, IDFT, PAPR reduction, and cyclic prefix (cyclic prefix, CP) insertion. The processing procedure of the receive end mainly includes CP removal, DFT, channel estimation and compensation, resource inverse mapping, demodulation, and channel decoding. It may be understood that, when the transmit end reduces the PAPR of the transmitted signal by using the reserved subcarrier, after receiving the transmitted signal of the transmit end, the receive end may directly perform resource inverse mapping and demodulation on a signal on the data subcarrier without paying attention to a signal on the reserved subcarrier.

In the foregoing PAPR reduction method, the part of subcarriers needs to be reserved to reduce the PAPR and not to send the wanted data, resulting in a loss of spectral efficiency.

In view of this, embodiments of this application provide a signal transmission method, a communication system, and a communication apparatus, to improve spectral efficiency. The method provided in embodiments of this application may be applied to the communication system shown in FIG. 1. Alternatively, the method provided in embodiments of this application may be applied to the communication system shown in FIG. 2. Alternatively, the method provided in embodiments of this application may be applied to a first communication apparatus, a second communication apparatus, and a third communication apparatus. The first communication apparatus and the third communication apparatus may be the terminal device described above, and the second communication apparatus may be the network device described above. Alternatively, the first communication apparatus and the third communication apparatus may be any two antenna bays at the transmit end described above, and the second communication apparatus may be the receive end described above.

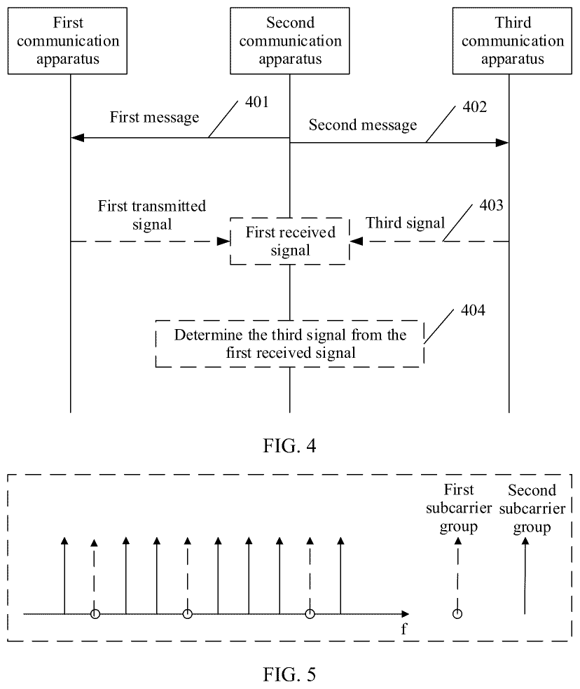

FIG. 4 is a diagram of interaction of a signal transmission method according to an embodiment of this application. As shown in FIG. 4, the method includes but is not limited to the following steps.
401: A second communication apparatus sends a first message, and correspondingly, a first communication apparatus receives the first message, where the first message includes first resource indication information, when the first resource indication information is a first value, the first resource indication information indicates a third communication apparatus to transmit data on a first subcarrier group of the first communication apparatus, and the first subcarrier group does not include a data subcarrier of the first communication apparatus.

For example, the data subcarrier of the first communication apparatus is a subcarrier used by the first communication apparatus to transmit data, and the first subcarrier group does not include the data subcarrier of the first communication apparatus, that is, the first communication apparatus does not transmit data on the first subcarrier group. For example, the first subcarrier group may include a reserved subcarrier used by the first communication apparatus to reduce a PAPR of a transmitted signal.

For example, the first subcarrier group may include one or more subcarriers, and the one or more subcarriers may be consecutive in frequency domain, or may be inconsecutive in frequency domain. This is not limited in this application.

For example, when the first resource indication information is the first value, the first resource indication information indicates the third communication apparatus to transmit data on the first subcarrier group of the first communication apparatus, and indicates the first communication apparatus to reduce the PAPR of the transmitted signal on the first subcarrier group.

For example, when the first resource indication information is a second value, the first resource indication information indicates the first communication apparatus to transmit data on the first subcarrier group. The first communication apparatus may determine, based on the value of the first resource indication information, whether to transmit data on the first subcarrier group, so that resources can be properly used, and a resource waste can be avoided.

It may be understood that the first value and the second value may be configured by the second communication apparatus, or may be negotiated by the first communication apparatus and the second communication apparatus. For example, the first value may be 1, and the second value may be 0. To be specific, when the first resource indication information is 1, the first resource indication information indicates the third communication apparatus to transmit data on the first subcarrier group. When the first resource indication information is 0, the first resource indication information indicates the first communication apparatus to transmit data on the first subcarrier group.

In some implementations, the first message may not include the first resource indication information, and the value of the first resource indication information may be indicated through other signaling in the first message. For example, when a value of the other signaling is A, the first communication apparatus and the second communication apparatus consider by default that the value of the first resource indication information is the first value or the second value. Alternatively, in some other implementations, the first message may not include the first resource indication information. When the first message includes a time-frequency resource corresponding to the first subcarrier group and a time-frequency resource corresponding to a second subcarrier group, the first communication apparatus and the second communication apparatus may determine that the first message indicates that the first resource indication information is the first value. In other words, the first message is used by the first communication apparatus to reduce the PAPR of the transmitted signal on the first subcarrier group and is used by the third communication apparatus to transmit data on the first subcarrier group.
402: The second communication apparatus sends a second message, and correspondingly, the third communication apparatus receives the second message, where the second message includes second resource indication information, and when the second resource indication information is the second value, the second resource indication information indicates the third communication apparatus to transmit data on the first subcarrier group.

For example, when the second resource indication information is the first value, the second resource indication information indicates the third communication apparatus to reduce the PAPR of the transmitted signal on the first subcarrier group, and indicates the first communication apparatus to transmit data on the first subcarrier group.

For example, when the second resource indication information is the second value, the second resource indication information indicates the third communication apparatus to transmit data on the first subcarrier group, and indicates the first communication apparatus to reduce the PAPR of the transmitted signal on the first subcarrier group.

For example, the second communication apparatus indicates, based on the first resource indication information, the first communication apparatus to reduce the PAPR of the transmitted signal on the first subcarrier group, and indicates, based on the second resource indication information, the third communication apparatus to transmit data on the first subcarrier group. It may be understood that the first resource indication information and the second resource indication information in the first message and the second message that are sent by the second communication apparatus have different values, to indicate one of the first communication apparatus and the third communication apparatus to transmit data on the first subcarrier group and the other of the first communication apparatus and the third communication apparatus to reduce the PAPR of the transmitted signal on the first subcarrier group. For example, the first resource indication information is the first value, and the second resource indication information is the second value. The first communication apparatus reduces the PAPR of the transmitted signal on the first subcarrier group, and the third communication apparatus transmits data on the first subcarrier group. For another example, the first resource indication information is the second value, and the first resource indication information is the first value. The third communication apparatus reduces the PAPR of the transmitted signal on the first subcarrier group, and the first communication apparatus transmits data on the first subcarrier group.

Optionally, when the first communication apparatus and the third communication apparatus may be any two antenna bays at a transmit end, and the second communication apparatus may be a receive end, the first message or the second message may be sent by the first communication apparatus or the second communication apparatus, and the first resource indication information or the second resource indication information indicates that there is transmission on the first subcarrier group.

In a possible implementation, the method shown in FIG. 4 includes step 403 and step 404.
403: The first communication apparatus sends a first transmitted signal, and the third communication apparatus sends a third signal, and correspondingly, the second communication apparatus receives a first received signal, where the first received signal is obtained by superimposing the first transmitted signal and the third signal.

For example, the first transmitted signal includes a first signal and a second signal, the first signal is a signal on the first subcarrier group, the second signal is a signal on the second subcarrier group, and the second subcarrier group includes the data subcarrier. For example, the second signal carries first data, and the first data is data to be transmitted by the first communication apparatus to the second communication apparatus. The first signal does not carry wanted data, and the first signal is related to the second signal.

For example, after receiving the second message, the third communication apparatus may transmit the third signal on the first subcarrier group based on the second resource indication information, where the third signal carries second data, and the second data is data to be sent by the third communication apparatus to the second communication apparatus.

In a possible implementation, a PAPR of the first transmitted signal is less than or equal to a PAPR of the second signal. In other words, the first communication apparatus reduces the PAPR of the transmitted signal on the first subcarrier group. For example, the first signal is generated on the first subcarrier group, and the first signal is used to enable the PAPR of the first transmitted signal to be less than or equal to that of the second signal. For example, the first communication apparatus may map the to-be-transmitted first data to the second subcarrier group to generate the second signal, generate the first signal on the first subcarrier group, and superimpose the first signal and the second signal to generate the first transmitted signal. For example, the first communication apparatus may perform peak clipping on the second signal based on the first signal, so that a PAPR of the generated first transmitted signal is less than the PAPR of the second signal.

In a possible implementation, the first message further includes a first time-frequency resource and first indication information, the first time-frequency resource indicates a time-frequency resource related to the first subcarrier group and a time-frequency resource related to the second subcarrier group, and the first indication information indicates a location of the first subcarrier group and a location of the second subcarrier group. The first communication apparatus generates the first signal and the second signal based on the first time-frequency resource and the first indication information.

For example, the first time-frequency resource indicates a time-frequency resource used by the first communication apparatus to send an uplink transmission signal, and the first time-frequency resource may include the time-frequency resource corresponding to the first subcarrier group and the time-frequency resource corresponding to the second subcarrier group. The first communication apparatus determines the location of the first subcarrier group and the location of the second subcarrier group based on the first time-frequency resource and the first indication information. The first communication apparatus may transmit the first transmitted signal on the first time-frequency resource.

For example, the first communication apparatus may perform resource mapping based on the location of the first subcarrier group and the location of the second subcarrier group, to generate the second signal. For example, the first communication apparatus may map the first data to the location of the second subcarrier group, set the location of the first subcarrier group to 0, and then generate the second signal through IDFT. Then, the first communication apparatus maps a particular sequence to the location of the first subcarrier group, and then generates the first signal through IDFT. The first communication apparatus performs peak clipping by superimposing the first signal and the second signal, to generate the first transmitted signal, so that a PAPR of the first transmitted signal is less than or equal to that of the second signal.

In a possible implementation, the second message further includes a second time-frequency resource and fourth indication information, the second time-frequency resource indicates the time-frequency resource related to the first subcarrier group, and the fourth indication information indicates the location of the first subcarrier group. The third communication apparatus sends the third signal on the first subcarrier group based on the second time-frequency resource and the fourth indication information.

For example, the third communication apparatus may determine the location of the first subcarrier group based on the second time-frequency resource and the fourth indication information, map the second data to the location of the first subcarrier group, and then generate the third signal through IDFT.

For example, the first time-frequency resource and the second time-frequency resource may be the same or may be different. When the first time-frequency resource is different from the second time-frequency resource, a bandwidth of the first time-frequency resource may be greater than a bandwidth of the second time-frequency resource, and a frequency domain resource corresponding to the first time-frequency resource may include a frequency domain resource corresponding to the second time-frequency resource. For example, the bandwidth of the first time-frequency resource is 100 Mbit/s, and the bandwidth of the second time-frequency resource may be 20 Mbit/s.

For example, the first indication information may include a first tone reservation (tone reservation, TR) pattern, and the fourth indication information may include a second TR pattern. The first TR pattern and the second TR pattern may be the same or may be different. For example, the first TR pattern corresponds to the first time-frequency resource, and the second TR pattern corresponds to the second time-frequency resource. FIG. 5 shows an example of a TR pattern. In FIG. 5, a dashed line indicates a location of the reserved subcarrier in the first subcarrier group, and a solid line indicates a location of the data subcarrier in the second subcarrier group.

For example, the first communication apparatus and the third communication apparatus may use a CP-OFDM waveform.
404: The second communication apparatus determines the third signal from the first received signal.

For example, after receiving the first received signal, the second communication apparatus needs to determine the first transmitted signal and the third signal from the first received signal. For example, the first transmitted signal includes the first signal sent by the first communication apparatus on the first subcarrier group and the second signal sent by the first communication apparatus on the second subcarrier group, and the third signal is a signal sent by the third communication apparatus on the first subcarrier group. Therefore, a signal that is of the first received signal and that is on the first subcarrier group is a superimposition of the first signal and the third signal, and a signal that is of the first received signal and that is on the second subcarrier group is the second signal.

In a possible implementation, that the second communication apparatus determines the third signal from the first received signal may include: The second communication apparatus determines the second signal that is of the first received signal and that is on the second subcarrier group; the second communication apparatus determines the first transmitted signal based on the second signal; and the second communication apparatus performs interference cancellation on the first received signal based on the first transmitted signal, to obtain the third signal.

For example, the first signal sent by the first communication apparatus on the first subcarrier group is related to the second signal sent on the second subcarrier group. Therefore, the second communication apparatus may determine the first signal based on the second signal, to reconstruct the first transmitted signal. Then, the second communication apparatus performs interference cancellation on the first received signal based on the first transmitted signal, that is, the second communication apparatus subtracts the first transmitted signal from the first received signal, to obtain the third signal.

For example, the second communication apparatus performs discrete Fourier transform (discrete fourier transform, DFT) on the first received signal, to determine the second signal that is of the first received signal and that is on the second subcarrier group.

In this embodiment of this application, the first communication apparatus does not transmit wanted data on the first subcarrier group. For example, the first communication apparatus may reduce a PAPR of the first transmitted signal by using the first subcarrier group. The second communication apparatus may indicate, based on the first resource indication information and the second resource indication information, the third communication apparatus to transmit data on the first subcarrier group, so that the first subcarrier group carries the data of the third communication apparatus, and spectrum resources of the first subcarrier group can be fully used. This avoids a waste of the spectrum resources and improves spectral efficiency.

In this embodiment of this application, the third communication apparatus may be a low-power-consumption device or a device that occupies a small bandwidth. For example, the third communication apparatus may include one or more low-power-consumption devices, and any one of the one or more low-power-consumption devices occupies one or more subcarriers. The first communication apparatus may be a high-throughput device, and the first communication apparatus may be applied to a scenario, for example, a smart home or an intelligent wearable.

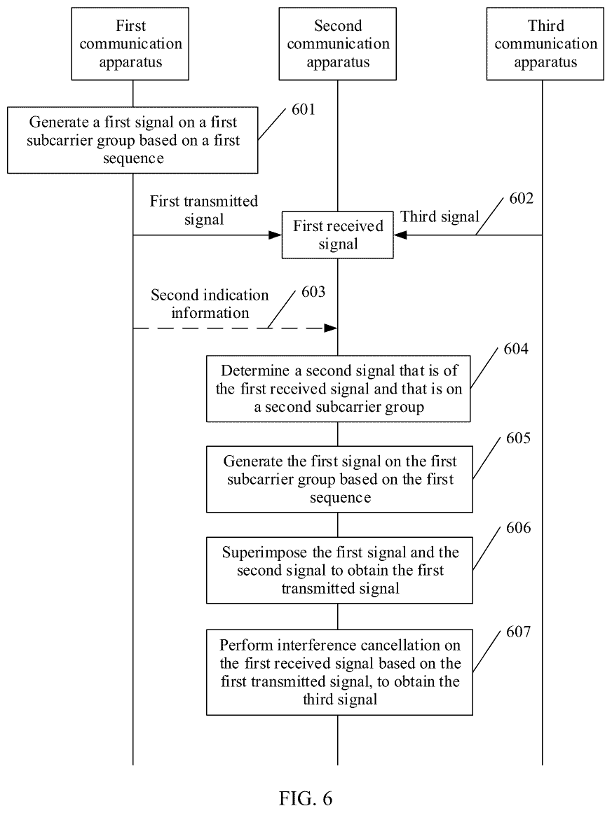

FIG. 6 is a diagram of interaction of another signal transmission method according to an embodiment of this application. As shown in FIG. 6, the method includes but is not limited to the following steps.
601: A first communication apparatus generates a first signal on a first subcarrier group based on a first sequence, where the first sequence is a sequence that is in a sequence group and that enables a PAPR of a first transmitted signal to meet a preset condition.

For example, the sequence group may be pre-agreed on by the first communication apparatus and the second communication apparatus, and the sequence group may include one or more sequences. The first communication apparatus maps the first sequence to the first subcarrier group, to generate the first signal.

For example, the preset condition may include a threshold condition or a smallest PAPR of the first transmitted signal. In other words, the first sequence may be a sequence that is in the sequence group and that enables the PAPR of the first transmitted signal to be smallest, or the first sequence may be any sequence that is in the sequence group and that enables the PAPR of the first transmitted signal to meet the threshold condition.

In a possible implementation, the first sequence may be the sequence that is in the sequence group and that enables the PAPR of the first transmitted signal to be smallest, and the first communication apparatus determines the sequence that is in the sequence group and that enables the PAPR of the first transmitted signal to be smallest as the first sequence. For example, the first communication apparatus may separately map the one or more sequences in the sequence group to the first subcarrier group, to obtain one or more first signals. Then, the first communication apparatus separately superimposes the one or more first signals and a second signal to obtain one or more first transmitted signals. The first communication apparatus sends one of the one or more first transmitted signals with a smallest PAPR, and determines a sequence corresponding to the one of the one or more first transmitted signals with the smallest PAPR as the first sequence. For example, the sequence group includes N sequences, and the N sequences are {S₁, S₂, . . . , S_{N}} respectively. The first communication apparatus may select, from the sequence group, a first sequence Sₙ that enables the PAPR of the first transmitted signal to be smallest, and generate and send the first transmitted signal based on Sₙ. For example, the first communication apparatus may further send a number of Sₙ to the second communication apparatus.

In this implementation, the first communication apparatus determines the sequence that is in the sequence group and that enables the PAPR of the first transmitted signal to be smallest as the first sequence, so that the PAPR of the first transmitted signal sent by the first communication apparatus is smallest, thereby avoiding or mitigating nonlinear distortion caused by an excessively high PAPR of the first transmitted signal.

In another possible implementation, the first sequence is any sequence that is in the sequence group and that enables the PAPR of the first transmitted signal to meet the threshold condition. For example, that the PAPR of the first transmitted signal meets the threshold condition may include that the PAPR of the first transmitted signal is less than a first threshold. The first threshold may be determined by the first communication apparatus, or may be determined by the second communication apparatus. For example, the first threshold may be determined based on a linear range of a power amplifier of the first communication apparatus.

For example, the first communication apparatus may generate the first signal based on sequences in the sequence group one by one, and superimpose the first signal and the second signal, to obtain the first transmitted signal. The first communication apparatus determines whether the PAPR of the first transmitted signal meets the threshold condition. When determining that the PAPR of the first transmitted signal meets the threshold condition, the first communication apparatus may determine a sequence that enables the first transmitted signal to meet the threshold condition as the first sequence, and send the first transmitted signal. It may be understood that in this implementation, after determining the first sequence, the first communication apparatus does not need to generate the first transmitted signal based on another sequence in the sequence group, so that the first communication apparatus can determine the first sequence and the first transmitted signal more quickly, and energy consumption of generating the first transmitted signal by the first communication apparatus based on the another sequence can be avoided.
602: The first communication apparatus sends the first transmitted signal, the third communication apparatus sends a third signal, and the second communication apparatus receives a first received signal, where the first received signal is obtained by superimposing the first transmitted signal and the third signal.

It may be understood that for specific descriptions of the first transmitted signal and the third signal, refer to the foregoing description. Details are not described herein again.

In a possible implementation, the method shown in FIG. 6 includes step 603.
603: The first communication apparatus sends second indication information, and correspondingly, the second communication apparatus receives the second indication information, where the second indication information indicates the first sequence.

For example, the second indication information may include a number of the first sequence. The first communication apparatus may indicate the first sequence based on the second indication information, so that the second communication apparatus can quickly determine the first sequence from the sequence group based on the second indication information.
604: The second communication apparatus determines the second signal that is of the first received signal and that is on a second subcarrier group.
605: The second communication apparatus generates the first signal on the first subcarrier group based on the first sequence, where the first sequence is the sequence that is in the sequence group and that enables the PAPR of the first transmitted signal to meet the preset condition.

For example, the second communication apparatus may map the first sequence to the first subcarrier group, to generate the first signal.

In a possible implementation, the second communication apparatus may determine the first sequence based on the second indication information. For example, the second indication information includes a number of the first sequence in the sequence group, and the second communication apparatus may determine the first sequence based on the number.

In another possible implementation, the second communication apparatus may determine the first sequence through blind detection. For example, the second communication apparatus may generate the first transmitted signal separately based on the one or more sequences in the sequence group, determine, from the one or more sequences, a sequence that enables the PAPR of the first transmitted signal to meet the preset condition, and determine the sequence as the first sequence.
606: The second communication apparatus superimposes the first signal and the second signal to obtain the first transmitted signal.
607: The second communication apparatus performs interference cancellation on the first received signal based on the first transmitted signal, to obtain the third signal.

In this embodiment of this application, the first communication apparatus and the second communication apparatus may determine, from the agreed sequence group, the first sequence that enables the PAPR of the first transmitted signal to meet the preset condition, so that the first signal can be directly generated on the first subcarrier group based on the first sequence, thereby reducing complexity of generating the first signal.

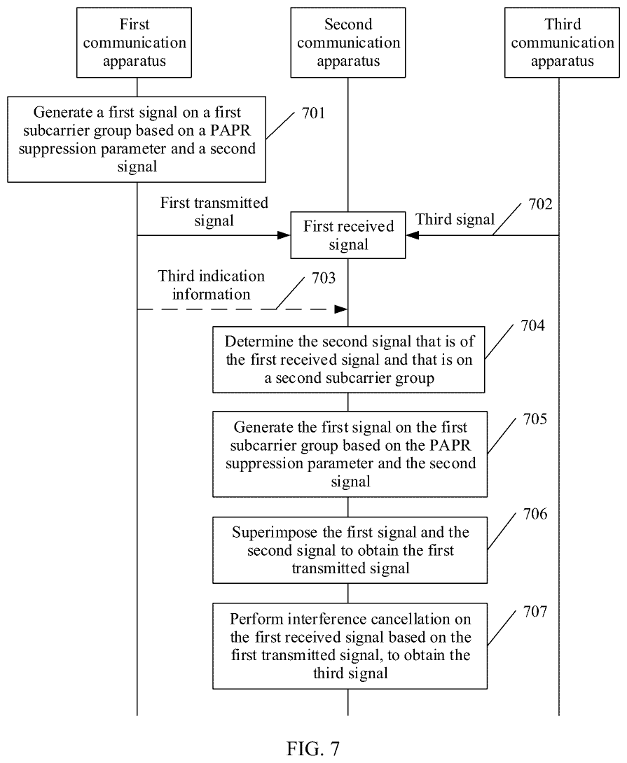

FIG. 7 is a diagram of interaction of still another signal transmission method according to an embodiment of this application. As shown in FIG. 7, the method includes but is not limited to the following steps.
701: A first communication apparatus generates a first signal on a first subcarrier group based on a PAPR suppression parameter and a second signal.

For example, the PAPR suppression parameter includes at least one of the following: a PAPR suppression threshold, tone reservation TR algorithm indication information, and a TR algorithm iteration round quantity. The TR algorithm indication information indicates a manner used by the first communication apparatus to perform PAPR suppression, for example, eliminating a single peak in one round of iteration, eliminating a plurality of peaks in one round of iteration, or an algorithm based on least squares.

For example, after mapping to-be-transmitted first data to a second subcarrier group, the first communication apparatus may generate the second signal through IDFT. The first communication apparatus may generate a fourth signal by using the first subcarrier group, and translate the fourth signal in time domain based on a power peak of the second signal, so that a peak of the fourth signal can be subtracted from the peak of the second signal, and a PAPR of a generated first transmitted signal is less than a PAPR of the second signal. For example, the fourth signal may also be referred to as a peak-clipped signal, a time-domain kernel, a time-domain original kernel, or a time-domain signal kernel.

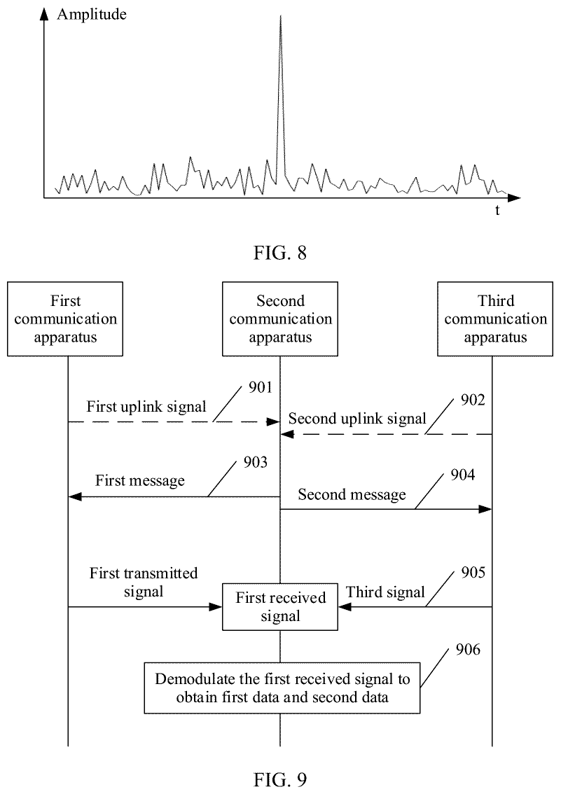

For example, a waveform of the fourth signal in time domain may be shown in FIG. 8, and the fourth signal includes one peak. The first communication apparatus may map a particular sequence to the first subcarrier group, to generate the fourth signal. For example, the particular sequence may be 1. The first communication apparatus determines a first peak of the second signal in time domain, and after the fourth signal is multiplied by a first value and translated, a peak of the fourth signal can be subtracted from the first peak, so that the first peak is less than or equal to the PAPR suppression threshold. It may be understood that the first coefficient is determined based on the first peak and the PAPR suppression threshold. For example, the first coefficient may be a difference between the first peak and the PAPR suppression threshold. For example, if the first peak is 8, and the PAPR suppression threshold is 5, the first coefficient may be 3.

For example, the second signal may include a plurality of peaks, and the first communication apparatus may perform peak clipping on the plurality of peaks based on the fourth signal through a plurality of rounds of iteration, to obtain the first transmitted signal. For example, a quantity of iterations of the first communication apparatus is the TR algorithm iteration round quantity. For example, after performing peak clipping on the second signal based on the fourth signal through the plurality of rounds of iteration, the first communication apparatus generates the first signal on the first subcarrier group.

For example, the PAPR suppression parameter may be determined by the second communication apparatus, and indicates the first communication apparatus to reduce, based on the PAPR suppression parameter, a PAPR of a transmitted signal. Alternatively, the PAPR suppression parameter may be determined by the first communication apparatus.
702: The first communication apparatus sends the first transmitted signal, the third communication apparatus sends a third signal, and the second communication apparatus receives a first received signal, where the first received signal is obtained by superimposing the first transmitted signal and the third signal.

It may be understood that for specific descriptions of the first transmitted signal and the third signal, refer to the foregoing description. Details are not described herein again.

In a possible implementation, the method shown in FIG. 7 includes step 703.
703: The first communication apparatus sends third indication information, and correspondingly, the second communication apparatus receives the third indication information. The third indication information indicates the PAPR suppression parameter.

For example, the third indication information may be included in the first transmitted signal, or the first communication apparatus may send the third indication information to the second communication apparatus based on another uplink signal.
704: The second communication apparatus determines the second signal that is of the first received signal and that is on the second subcarrier group.
705: The second communication apparatus generates the first signal on the first subcarrier group based on the PAPR suppression parameter and the second signal.

It may be understood that, for a specific implementation of step 505, refer to a process in which the first communication apparatus generates the first signal in step 501. Details are not described herein again.
706: The second communication apparatus superimposes the first signal and the second signal to obtain the first transmitted signal.
707: The second communication apparatus performs interference cancellation on the first received signal based on the first transmitted signal, to obtain the third signal.

In this embodiment of this application, the first communication apparatus may reduce the PAPR of the transmitted signal based on the PAPR suppression parameter, so that the first transmitted signal has a low PAPR, thereby avoiding or mitigating non-linear distortion caused by an excessively high PAPR of the first transmitted signal. In addition, the first communication apparatus may indicate the PAPR suppression parameter to the second communication apparatus based on the third indication information, so that the second communication apparatus can reconstruct the first signal based on the PAPR suppression parameter, and can determine the third signal from the first received signal.

FIG. 9 is a diagram of interaction of still another signal transmission method according to an embodiment of this application. As shown in FIG. 9, the method further includes but is not limited to the following steps.

In a possible implementation, the method shown in FIG. 9 includes step 901 and step 902.
901: A first communication apparatus sends a first uplink signal, and correspondingly, a second communication apparatus receives the first uplink signal.

For example, the second communication apparatus may measure a power of the first uplink signal, to determine a power of an uplink signal sent by the first communication apparatus.
902: A third communication apparatus sends a second uplink signal, and correspondingly, the second communication apparatus receives the second uplink signal.

For example, the second communication apparatus may measure a power of the second uplink signal, to determine a power of an uplink signal sent by the third communication apparatus.
903: The second communication apparatus sends a first message, and correspondingly, the first communication apparatus receives the first message, where the first message includes first resource indication information. When the first resource indication information is a first value, the first resource indication information indicates the third communication apparatus to transmit data on a first subcarrier group of the first communication apparatus, and the first subcarrier group does not include a data subcarrier of the first communication apparatus.

For example, the first message further includes a first threshold, and the first threshold is used to limit a power of a first signal transmitted by the first communication apparatus on the first subcarrier group. For example, the power of the first signal is less than or equal to the first threshold. The first threshold is related to at least one of the following: a channel capacity, a power of a third signal, a modulation order of the third signal, and a bit rate of the third signal, and the third signal is a signal sent by the third communication apparatus on the first subcarrier group.

For example, the second communication apparatus indicates the third communication apparatus to transmit data on the first subcarrier group, and a signal received by the second communication apparatus on the first subcarrier group is a superimposition of the first signal and the third signal. The second communication apparatus may use the first signal as interference to the third signal, and limit the power of the first signal, so that the second communication apparatus can demodulate second data carried in the third signal.

For example, when the bit rate of the third signal is less than the channel capacity, the second communication apparatus may demodulate, from the received signal, the second data carried in the third signal. The channel capacity may be determined based on the power of the third signal, the power of the first signal, and a channel bandwidth. For example, the power of the first signal, the power of the third signal, the channel bandwidth, and the bit rate of the third signal meet the following formula:

R≤B log₂(1+S/N) (1)

R is the bit rate of the third signal, B is the channel bandwidth, S is the power of the third signal, and N is a sum of the power of the first signal and a white noise power. The second communication apparatus may determine the first threshold according to the foregoing formula (1), so that the power of the first signal can meet the formula (1).

For example, the second communication apparatus may use the power of the second uplink signal as the power of the third signal, that is, the second communication apparatus may determine the first threshold based on the power of the second uplink signal.

For example, the first message further includes a first time-frequency resource and first indication information. It may be understood that for specific descriptions of the first time-frequency resource and the first indication information, refer to the foregoing related descriptions. Details are not described herein again.
904: The second communication apparatus sends a second message, and correspondingly, the third communication apparatus receives the second message, where the second message includes second resource indication information, and when the second resource indication information is a second value, the second resource indication information indicates the third communication apparatus to transmit data on the first subcarrier group.

For example, the second message may further include a second threshold, and the second threshold is used to limit the power of the third signal. For example, the power of the third signal is greater than or equal to the second threshold. For example, the second threshold may be related to at least one of the channel capacity, the power of the first signal, the modulation order of the third signal, and the bit rate of the third signal.

For example, the second communication apparatus may determine the second threshold according to the foregoing formula (1), so that the power of the third signal can meet the formula (1).
905: The first communication apparatus sends a first transmitted signal, the third communication apparatus sends the third signal, and the second communication apparatus receives a first received signal, where the first received signal is obtained by superimposing the first transmitted signal and the third signal.
906: The second communication apparatus demodulates the first received signal to obtain first data and the second data.

For example, the first transmitted signal includes a first signal and a second signal, the first signal is a signal sent by the first communication apparatus on the first subcarrier group, and the second signal is a signal sent by the first communication apparatus on a second subcarrier group. The third signal is a signal sent by the third communication apparatus on the first subcarrier group. The second signal carries the first data, and the third signal carries the second data.

For example, the second communication apparatus may perform DFT on the first received signal to obtain a signal of the first received signal in frequency domain, to obtain the second signal and a signal that is of the first received signal and that is on a first subcarrier. The second communication apparatus performs resource inverse mapping and demodulation on the second signal, to obtain the first data. The second communication apparatus performs resource inverse mapping and demodulation on the signal on the first subcarrier, to obtain the second data.

In this embodiment of this application, the second communication apparatus may use the first signal as interference to the third signal, and limit the power of the first signal, so that the second communication apparatus can demodulate, from the signal received on the first subcarrier, the second data carried in the third signal, and the third communication apparatus can transmit data on the first subcarrier group, thereby allocating resources more properly. In addition, the second communication apparatus does not need to reconstruct the first transmitted signal sent by the first communication apparatus, so that complexity can be reduced.

A communication apparatus provided in an embodiment of this application is described below.

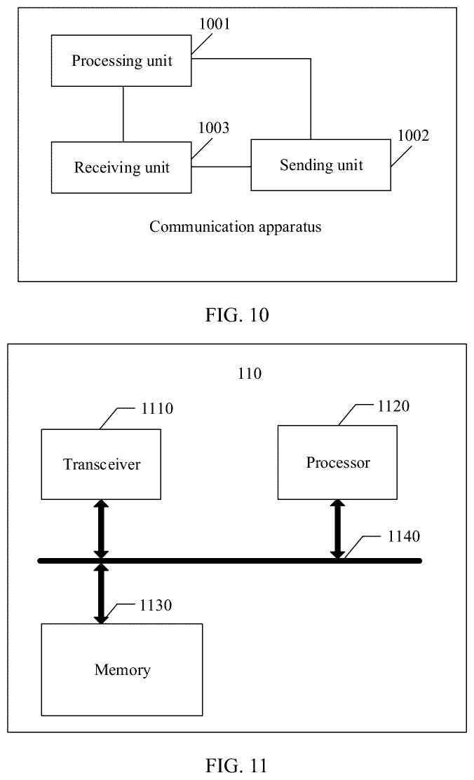

In this application, the communication apparatus is divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that, in this application, module division is an example, and is merely a logical function division. In actual implementation, another division manner may be used. The following describes in detail communication apparatuses in embodiments of this application with reference to FIG. 10 to FIG. 12.

FIG. 10 is a diagram of a structure of a communication apparatus according to an embodiment of this application. As shown in FIG. 10, the communication apparatus includes a processing unit 1001, a sending unit 1002, and a receiving unit 1003.

In some embodiments of this application, the communication apparatus may be the first communication apparatus shown above. To be specific, the communication apparatus shown in FIG. 10 may be configured to perform the steps, the functions, or the like performed by the first communication apparatus in the foregoing method embodiments. For example, the communication apparatus may be a beamformed transmit device, a chip, or the like. This is not limited in embodiments of this application.

The receiving unit 1003 is configured to receive a first message.

The sending unit 1002 is configured to send a first transmitted signal.

Optionally, the processing unit 1001 is configured to generate a first signal and a second signal.

Optionally, the sending unit 1002 is further configured to send second indication information.

Optionally, the sending unit 1002 is further configured to send third indication information.

It may be understood that for specific descriptions of the first message, the first transmitted signal, the first signal, the second signal, the first indication information, the second indication information, and the like, refer to the foregoing method embodiments, such as related descriptions of the methods shown in FIG. 4, FIG. 6, FIG. 7, and FIG. 9. Details are not described herein again.

It may be understood that specific descriptions of the processing unit, the sending unit, and the receiving unit shown in embodiments of this application are merely examples. For specific functions or steps performed by the processing unit, the sending unit, and the receiving unit, refer to the foregoing method embodiments. Details are not described herein again.

FIG. 10 is reused. In some other embodiments of this application, the communication apparatus may be the second communication apparatus shown above. To be specific, the communication apparatus shown in FIG. 10 may be configured to perform the steps, the functions, or the like performed by the second communication apparatus in the foregoing method embodiments. For example, the communication apparatus may be a beamformed receive device, a chip, or the like. This is not limited in embodiments of this application.

The sending unit 1002 is configured to send a first message and a second message.

Optionally, the receiving unit 1003 is configured to receive a first received signal; and the processing unit 1001 is configured to determine a third signal from the first received signal.

Optionally, the receiving unit 1003 is further configured to receive second indication information.

Optionally, the receiving unit 1003 is further configured to receive third indication information.

It may be understood that for specific descriptions of the first message, the second message, the first received signal, the first signal, the second signal, the third signal, the first indication information, the second indication information, and the like, refer to the foregoing method embodiments, such as related descriptions of the methods shown in FIG. 4, FIG. 6, FIG. 7, and FIG. 9. Details are not described herein again.

It may be understood that specific descriptions of the receiving unit, the sending unit, and the processing unit shown in embodiments of this application are merely examples. For specific functions or steps performed by the receiving unit, the sending unit, and the processing unit, refer to the foregoing method embodiments. Details are not described herein again.

FIG. 10 is reused. In some other embodiments of this application, the communication apparatus may be the third communication apparatus shown above. To be specific, the communication apparatus shown in FIG. 10 may be configured to perform the steps, the functions, or the like performed by the third communication apparatus in the foregoing method embodiments. For example, the communication apparatus may be a beamformed receive device, a chip, or the like. This is not limited in embodiments of this application.

The receiving unit 1003 is configured to receive a second message.

The sending unit 1002 is configured to send a third signal.

It may be understood that for specific descriptions of the first message, the second message, the first received signal, the first signal, the second signal, the third signal, the first indication information, the second indication information, and the like, refer to the foregoing method embodiments, such as related descriptions of the methods shown in FIG. 4, FIG. 6, FIG. 7, and FIG. 9. Details are not described herein again.

It may be understood that specific descriptions of the receiving unit, the sending unit, and the processing unit shown in embodiments of this application are merely examples. For specific functions or steps performed by the receiving unit, the sending unit, and the processing unit, refer to the foregoing method embodiments. Details are not described herein again.

The foregoing describes the first communication apparatus, the second communication apparatus, and the third communication apparatus in embodiments of this application. The following describes possible product forms of the first communication apparatus, the second communication apparatus, and the third communication apparatus. It should be understood that any form of product that has a function of the first communication apparatus described in FIG. 10, any form of product that has a function of the second communication apparatus described in FIG. 10, or any form of product that has a function of the third communication apparatus described in FIG. 10 fall within the protection scope of embodiments of this application. It should be further understood that the following descriptions are merely an example, and does not limit product forms of the first communication apparatus, the second communication apparatus, and the third communication apparatus in embodiments of this application.

In the communication apparatus shown in FIG. 10, the processing unit 1001 may be one or more processors, the sending unit 1002 may be a transmitter, and the receiving unit 1003 may be a receiver, or the sending unit and the receiving unit are integrated into one component, for example, a transceiver. Alternatively, the processing unit 1001 may be one or more processors (or the processing unit 1001 may be one or more logic circuits), the sending unit 1002 may be an output interface, the receiving unit 1003 may be an input interface, and the input interface and the output interface may be integrated into one unit, for example, an input/output interface. Details are described below.

In a possible implementation, in the communication apparatus shown in FIG. 10, the processing unit 1001 may be one or more processors, and the sending unit 1002 and the receiving unit 1003 are integrated into one component, for example, a transceiver. In embodiments of this application, the processor and the transceiver may be coupled, and a connection manner between the processor and the transceiver is not limited in embodiments of this application.

As shown in FIG. 11, a communication apparatus 110 includes one or more processors 1120 and a transceiver 1110.

For example, when the communication apparatus is configured to perform the steps, the methods, or the functions performed by the first communication apparatus, the transceiver 1110 is configured to receive a first message and send a first transmitted signal. Optionally, the processor 1120 is configured to generate a first signal and a second signal. Optionally, the transceiver 1110 is further configured to send second indication information. Optionally, the transceiver 1110 is further configured to send third indication information.

For example, when the communication apparatus is configured to perform the steps, the methods, or the functions performed by the second communication apparatus, the transceiver 1110 is configured to send a first message and a second message. Optionally, the transceiver 1110 is further configured to receive a first received signal; and the processor 1120 is configured to determine a third signal from the first received signal. Optionally, the transceiver 1110 is further configured to receive second indication information. Optionally, the transceiver 1110 is further configured to receive third indication information.

For example, when the communication apparatus is configured to perform the steps, the methods, or the functions performed by the third communication apparatus, the transceiver 1110 is configured to receive a second message and send a third signal.

It may be understood that for specific descriptions of the first message, the second message, the first transmitted signal, the first signal, the second signal, the third signal, the second indication information, the third indication information, and the like, refer to the foregoing method embodiments, such as related descriptions of the methods shown in FIG. 4, FIG. 6, FIG. 7, and FIG. 9. Details are not described herein again.

It may be understood that for specific descriptions of the processor and the transceiver, refer to the descriptions of the processing unit, the sending unit, and the receiving unit shown in FIG. 10. Details are not described herein again.

In each implementation of the communication apparatus shown in FIG. 10, the transceiver may include a receiver and a transmitter. The receiver is configured to perform a receiving function (or operation), and the transmitter is configured to perform a transmitting function (or operation). The transceiver is configured to communicate with another device/apparatus via a transmission medium.

Optionally, the communication apparatus 110 may further include one or more memories 1130, configured to store program instructions and/or data. The memory 1130 is coupled to the processor 1120. The coupling in embodiments of this application may be an indirect coupling or a communication connection between apparatuses, units, or modules in an electrical form, a mechanical form, or another form, and is used for information exchange between the apparatuses, the units, or the modules. The processor 1120 may operate in cooperation with the memory 1130. The processor 1120 may execute the program instructions stored in the memory 1130. Optionally, at least one of the one or more memories may be included in the processor.

A specific connection medium between the transceiver 1110, the processor 1120, and the memory 1130 is not limited in embodiments of this application. In embodiments of this application, the memory 1130, the processor 1120, and the transceiver 1110 are connected through a bus 1140 in FIG. 11. The bus is represented by a thick line in FIG. 11. A manner of a connection between other components is merely an example for description, and is not limited thereto. The bus may be classified into an address bus, a data bus, a control bus, and the like. For ease of representation, only one bold line is used to represent the bus in FIG. 11, but this does not mean that there is only one bus or only one type of bus.

In embodiments of this application, the processor may be a general-purpose processor, a digital signal processor, an application-specific integrated circuit, a field programmable gate array or another programmable logic device, a discrete gate or transistor logic device, a discrete hardware component, or the like. The processor can implement or execute the methods, the steps, and the logical block diagrams disclosed in embodiments of this application. The general-purpose processor may be a microprocessor or any conventional processor or the like. The steps of the methods disclosed in combination with embodiments of this application may be directly implemented by a hardware processor, or may be implemented by using a combination of hardware and software modules in the processor, or the like.

In embodiments of this application, the memory may include but is not limited to a nonvolatile memory such as a hard disk drive (hard disk drive, HDD) or a solid-state drive (solid-state drive, SSD), a random access memory (Random Access Memory, RAM), an erasable programmable read-only memory (Erasable Programmable ROM, EPROM), a read-only memory (Read-Only Memory, ROM), or a portable read-only memory (Compact Disc Read-Only Memory, CD-ROM). The memory is any storage medium that can be used to carry or store program code in a form of an instruction or a data structure and that can be read and/or written by a computer (for example, the communication apparatus shown in this application). However, this application is not limited thereto. The memory in embodiments of this application may alternatively be a circuit or any other apparatus that can implement a storage function, and is configured to store the program instructions and/or the data.

The processor 1120 is mainly configured to: process a communication protocol and communication data, control the entire communication apparatus, execute a software program, and process data of the software program. The memory 1130 is mainly configured to store the software program and data. The transceiver 1110 may include a control circuit and an antenna. The control circuit is mainly configured to: perform conversion between a baseband signal and a radio frequency signal and process the radio frequency signal. The antenna is mainly configured to receive and send a radio frequency signal in a form of an electromagnetic wave. The input/output apparatus, such as a touchscreen, a display, or a keyboard, is mainly configured to: receive data input by a user and output data to the user.

After the communication apparatus is powered on, the processor 1120 may read the software program in the memory 1130, interpret and execute instructions of the software program, and process data of the software program. When data needs to be sent in a wireless manner, the processor 1120 performs baseband processing on the to-be-sent data, and then outputs a baseband signal to a radio frequency circuit, and the radio frequency circuit performs radio frequency processing on the baseband signal, and then sends a radio frequency signal to the outside in a form of an electromagnetic wave through the antenna. When data is sent to the communication apparatus, the radio frequency circuit receives the radio frequency signal through the antenna, converts the radio frequency signal into a baseband signal, and outputs the baseband signal to the processor 1120. The processor 1120 converts the baseband signal into data and processes the data.

In another implementation, the radio frequency circuit and the antenna may be disposed independently of a processor that performs baseband processing. For example, in a distributed scenario, the radio frequency circuit and the antenna may be remotely disposed independent of the communication apparatus.

It may be understood that the communication apparatus shown in embodiments of this application may alternatively include more components than those shown in FIG. 11, or the like. This is not limited in embodiments of this application. The methods performed by the processor and the transceiver are merely examples. For specific steps performed by the processor and the transceiver, refer to the methods described above.

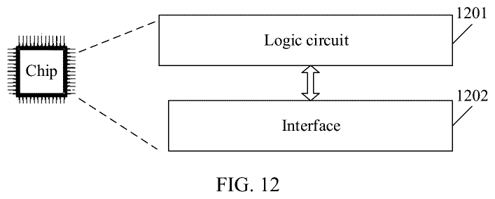

In another possible implementation, in the communication apparatus shown in FIG. 10, the processing unit 1001 may be one or more logic circuits, the sending unit 1002 may be an output interface, the receiving unit 1003 may be an input interface, and the input interface and the output interface may be integrated into one unit, for example, an input/output interface. The input/output interface is also referred to as a communication interface, an interface circuit, an interface, or the like. As shown in FIG. 12, a communication apparatus shown in FIG. 12 includes a logic circuit 1201 and an interface 1202. To be specific, the processing unit 1001 may be implemented through the logic circuit 1201, and the sending unit 1002 and the receiving unit 1003 may be implemented through the interface 1202. The logic circuit 1201 may be a chip, a processing circuit, an integrated circuit, a system on chip (system on chip, SoC), or the like. The interface 1202 may be a communication interface, an input/output interface, a pin, or the like. For example, FIG. 12 shows an example in which the communication apparatus is a chip. The chip includes a logic circuit 1201 and an interface 1202.

In embodiments of this application, the logic circuit and the interface may be coupled to each other. A specific manner of connection between the logical circuit and the interface is not limited in embodiments of this application.

For example, when the communication apparatus is configured to perform the methods, the functions, or the steps performed by the first communication apparatus, the interface 1202 is configured to receive a first message and send a first transmitted signal. Optionally, the logic circuit 1201 is configured to generate a first signal and a second signal. Optionally, the interface 1202 is further configured to send second indication information. Optionally, the interface 1202 is further configured to send third indication information.

For example, when the communication apparatus is configured to perform the methods, the functions, or the steps performed by the second communication apparatus, the interface 1202 is configured to send a first message and a second message. Optionally, the interface 1202 is further configured to receive a first received signal; and the logic circuit 1201 is configured to determine a third signal from the first received signal. Optionally, the interface 1202 is further configured to receive second indication information. Optionally, the interface 1202 is further configured to receive third indication information.

For example, when the communication apparatus is configured to perform the steps, the methods, or the functions performed by the fourth communication apparatus, the interface 1202 is configured to receive a second message and send a third signal.

It may be understood that the communication apparatus shown in embodiments of this application may implement the methods provided in embodiments of this application in a form of hardware, or may implement the methods provided in embodiments of this application in a form of software. This is not limited in embodiments of this application.

It may be understood that for specific descriptions of the first message, the second message, the first transmitted signal, the first signal, the second signal, the third signal, the second indication information, the third indication information, and the like, refer to the foregoing method embodiments, such as related descriptions of the methods shown in FIG. 4, FIG. 6, FIG. 7, and FIG. 9. Details are not described herein again.

For specific implementations of embodiments shown in FIG. 12, refer to the foregoing embodiments. Details are not described herein again.

An embodiment of this application further provides a communication system. The communication system includes a first communication apparatus, a second communication apparatus, and a third communication apparatus. The first communication apparatus, the second communication apparatus, and the third communication apparatus may be configured to perform the method in any one of the foregoing embodiments (as shown in FIG. 4, FIG. 6, FIG. 7, FIG. 9, and the like).

In addition, this application further provides a computer program. The computer program is used to implement operations and/or processing performed by the first communication apparatus in the methods provided in this application.

This application further provides a computer program. The computer program is used to implement operations and/or processing performed by the second communication apparatus in the methods provided in this application.

This application further provides a computer program. The computer program is used to implement operations and/or processing performed by the third communication apparatus in the method provided in this application.

This application further provides a computer-readable storage medium. The computer-readable storage medium stores computer code. When the computer code is run on a computer, the computer is enabled to perform operations and/or processing performed by the first communication apparatus in the methods provided in this application.

This application further provides a computer-readable storage medium. The computer-readable storage medium stores computer code. When the computer code is run on a computer, the computer is enabled to perform operations and/or processing performed by the second communication apparatus in the methods provided in this application.

This application further provides a computer-readable storage medium. The computer-readable storage medium stores computer code. When the computer code is run on a computer, the computer is enabled to perform operations and/or processing performed by the third communication apparatus in the method provided in this application.

This application further provides a computer program product. The computer program product includes computer code or a computer program. When the computer code or the computer program is run on a computer, operations and/or processing performed by the first communication apparatus in the methods provided in this application are/is performed.

This application further provides a computer program product. The computer program product includes computer code or a computer program. When the computer code or the computer program is run on a computer, operations and/or processing performed by the second communication apparatus in the methods provided in this application are/is performed.

This application further provides a computer program product. The computer program product includes computer code or a computer program. When the computer code or the computer program is run on a computer, operations and/or processing performed by the third communication apparatus in the method provided in this application are/is performed.

An embodiment of this application further provides a chip or a chip system, including a processor, configured to perform the method in any one of the foregoing embodiments (as shown in FIG. 4, FIG. 6, FIG. 7, FIG. 9, and the like).

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one location, or may be distributed on a plurality of network units. Some or all of the units may be selected based on an actual requirement to implement the technical effect of the solutions provided in embodiments of this application.

In addition, function units in embodiments of this application may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to the conventional technologies, or all or some of the technical solutions may be implemented in a form of a software product. The computer software product is stored in a readable storage medium and includes a plurality of instructions for instructing a computer device (which may be a personal computer, a server, or a network device) to perform all or some of the steps of the methods described in embodiments of this application. The readable storage medium includes any medium that can store program code, such as a USB flash drive, a removable hard disk, a read-only memory (read-only memory, ROM), a random access memory (random access memory, RAM), a magnetic disk, or an optical disc.

What is claimed is:

1. A signal transmission method, comprising:
receiving, by a first communication apparatus, a first message sent by a second communication apparatus, wherein the first message comprises first resource indication information, when the first resource indication information is a first value, the first resource indication information indicates a third communication apparatus to transmit data on a first subcarrier group of the first communication apparatus, and the first subcarrier group does not comprise a data subcarrier of the first communication apparatus; and
sending, by the first communication apparatus, a first transmitted signal based on the first message.

2. The method according to claim 1, wherein the first transmitted signal comprises a first signal and a second signal, the first signal is a signal on the first subcarrier group, the second signal is a signal on a second subcarrier group, and the second subcarrier group comprises the data subcarrier.

3. The method according to claim 2, wherein a peak-to-average power ratio (PAPR) of the first transmitted signal is less than or equal to a PAPR of the second signal.

4. The method according to claim 2, wherein the first message further comprises a first time-frequency resource and first indication information, the first time-frequency resource indicates a time-frequency resource related to the first subcarrier group and a time-frequency resource related to the second subcarrier group, and the first indication information indicates a location of the first subcarrier group and a location of the second subcarrier group; and the method further comprises:
generating, by the first communication apparatus, the first signal and the second signal based on the first time-frequency resource and the first indication information.

5. The method according to claim 2, wherein the method further comprises:
generating, by the first communication apparatus, the first signal on the first subcarrier group based on a first sequence, wherein the first sequence is a sequence that is in a sequence group and that enables the PAPR of the first transmitted signal to meet a preset condition.

6. The method according to claim 3, wherein the method further comprises:
sending, by the first communication apparatus, second indication information, wherein the second indication information indicates the first sequence.

7. The method according to claim 2, wherein the method further comprises:
generating, by the first communication apparatus, the first signal on the first subcarrier group based on a PAPR suppression parameter and the second signal; and
sending, by the first communication apparatus, third indication information, wherein the third indication information indicates the PAPR suppression parameter.

8. The method according to claim 2, wherein the first message further comprises a first threshold, and
a power of the first signal is less than or equal to the first threshold, the first threshold is related to at least one of the following: a channel capacity, a power of a third signal, a modulation order of the third signal, and a bit rate of the third signal, and the third signal is a signal sent by the third communication apparatus on the first subcarrier group.

9. A communication apparatus, comprising a processor and a memory, wherein
the memory is configured to store computer-executable instructions; and
the processor is configured to execute the computer-executable instructions, so that the steps are performed, the steps comprising:
receiving, by a first communication apparatus, a first message sent by a second communication apparatus, wherein the first message comprises first resource indication information, when the first resource indication information is a first value, the first resource indication information indicates a third communication apparatus to transmit data on a first subcarrier group of the first communication apparatus, and the first subcarrier group does not comprise a data subcarrier of the first communication apparatus; and
sending, by the first communication apparatus, a first transmitted signal based on the first message.

10. The apparatus according to claim 9, wherein the first transmitted signal comprises a first signal and a second signal, the first signal is a signal on the first subcarrier group, the second signal is a signal on a second subcarrier group, and the second subcarrier group comprises the data subcarrier.

11. The apparatus according to claim 10, wherein a peak-to-average power ratio (PAPR) of the first transmitted signal is less than or equal to a PAPR of the second signal.

12. The apparatus according to claim 10, wherein the first message further comprises a first time-frequency resource and first indication information, the first time-frequency resource indicates a time-frequency resource related to the first subcarrier group and a time-frequency resource related to the second subcarrier group, and the first indication information indicates a location of the first subcarrier group and a location of the second subcarrier group; and the method further comprises:
generating, by the first communication apparatus, the first signal and the second signal based on the first time-frequency resource and the first indication information.

13. The apparatus according to claim 10, wherein the steps further comprises:
generating, by the first communication apparatus, the first signal on the first subcarrier group based on a first sequence, wherein the first sequence is a sequence that is in a sequence group and that enables the PAPR of the first transmitted signal to meet a preset condition.

14. The apparatus according to claim 11, wherein the steps further comprises:
sending, by the first communication apparatus, second indication information, wherein the second indication information indicates the first sequence.

15. The apparatus according to claim 11, wherein the steps further comprises:
generating, by the first communication apparatus, the first signal on the first subcarrier group based on a PAPR suppression parameter and the second signal; and
sending, by the first communication apparatus, third indication information, wherein the third indication information indicates the PAPR suppression parameter.

16. A computer-readable storage medium, wherein the computer-readable storage medium is configured to store a computer program, and when the computer program is executed, the steps are performed, the steps comprising:
receiving, by a first communication apparatus, a first message sent by a second communication apparatus, wherein the first message comprises first resource indication information, when the first resource indication information is a first value, the first resource indication information indicates a third communication apparatus to transmit data on a first subcarrier group of the first communication apparatus, and the first subcarrier group does not comprise a data subcarrier of the first communication apparatus; and
sending, by the first communication apparatus, a first transmitted signal based on the first message.

17. The medium according to claim 16, wherein the first transmitted signal comprises a first signal and a second signal, the first signal is a signal on the first subcarrier group, the second signal is a signal on a second subcarrier group, and the second subcarrier group comprises the data subcarrier.

18. The medium according to claim 17, wherein a peak-to-average power ratio (PAPR) of the first transmitted signal is less than or equal to a PAPR of the second signal.

19. The medium according to claim 17, wherein the first message further comprises a first time-frequency resource and first indication information, the first time-frequency resource indicates a time-frequency resource related to the first subcarrier group and a time-frequency resource related to the second subcarrier group, and the first indication information indicates a location of the first subcarrier group and a location of the second subcarrier group; and the method further comprises:
generating, by the first communication apparatus, the first signal and the second signal based on the first time-frequency resource and the first indication information.

20. The medium according to claim 17, wherein the steps further comprises:
generating, by the first communication apparatus, the first signal on the first subcarrier group based on a first sequence, wherein the first sequence is a sequence that is in a sequence group and that enables the PAPR of the first transmitted signal to meet a preset condition.
